(19) United States
(12) Patent Application Publication
(10) Pub. No.: US 2010/0074390 A1
(43) Pub. Date: Mar. 25, 2010

(54) METHOD FOR WEATHER MODIFICATION AND VAPOR GENERATOR FOR WEATHER MODIFICATION

(76) Inventors: Tomoaki Nakamura, Tokyo (JP); Katsuhiko Nakamura, Tokyo (JP); Takafusa Nakamura, Chiba (JP); Yoshinori Watanabe, Tokyo (JP)

Correspondence Address: WENDEROTH, LIND & PONACK, L.L.P., 1030 15th Street, N.W.,, Suite 400 East, Washington, DC, 20005-1503, US

(21) Appl. No.: 12/446,281

(22) PCT Filed: Oct. 24, 2007
(86) PCT No.: PCT/JP2007/070726

§ 371 Date: Apr. 20, 2009

(30) Foreign Application Priority Data
Oct. 26, 2006 (JP) 2006-316264

(51) Int. Cl. G21C 19/28

(52) U.S. Cl. 376/391

(57) ABSTRACT

A nuclear fusion reactor (2) or nuclear fission reactor (22) is used as a heat source. A heat exchanger (11 or 37) that contains water to be heated (15) is used for water vapor generation. A circulating pipe (10 or 26) through which a fluid for cooling the nuclear fusion reactor or nuclear fission reactor or for conducting heat exchange circulates is disposed so as to extend in the heat exchanger and be in contact with the water to be heated. Water vapor is thus generated. This water vapor is jetted toward the sky at a state of collimation through a vapor discharge pipe (12 or 36). A cloud for blocking sunlight is formed in the sky from the water vapor jetted to reduce the temperature of the earth surface. This enables a weather modification without discharging any greenhouse gas, e.g., CO₂.

### TECHNICAL FIELD

The present invention relates to a method for weather modification, comprising generating an enormous volume of vapor in an enforced manner as well as a vapor generator for weather modification, so as to suppress various problems of the global warming phenomenon emerging through for example artificial disruptions of natural environment.

### BACKGROUND ART

The global warming phenomenon as a current issue is due to the elevation of the temperature of the global surface (including the temperature on seawater surface) via the increase of gases with green house effects, such as carbon dioxide, methane and nitrous oxide because of excessive uses of petroleum fuel and the like, which leads to thawing of ice and permanent frozen soil in the polar regions such as the South pole and the North pole, the occurrence of the el Nino phenomenon, desert enlargement, and destructions of natural environment due to localized torrential downpours or acid rain, so that abnormal weather phenomena emerge globally.

As the method or apparatus for modifying or improving such weather phenomena, plural techniques (inventions) are known. For example, the large-scale vapor mass generation method and the large-scale vapor mass generator disclosed in JP-A-2004-236650 (reference 1) are known. By the known method, a space sealed with a space-forming material is formed into a dome-like shape in the sky over a pond; vapor evaporating from the pond is reserved in the sealed space; when the reserved vapor reaches a given volume (a saturation state), the ceiling of the space formed into the dome-like shape is opened, to jet the reserved vapor mass into the sky with an inner pressure in the sealed space or with a gas discharge fan, so that moist air can be transferred to the desert; when the vapor mass ascends to the sky, the surrounding air temperature decreases to cool the vapor mass to condensate the vapor mass with atmospheric dust as a nucleus, so that small water droplets are generated to possibly allow the raining mechanism to work.

As an artificial raining method and an apparatus therefor, for example, those with the constitutions as disclosed in JP-A-2005-224151 (reference 2) are also known. By the artificial raining method, gas hydrates in crystal structures as prepared by placing gas molecules of at least one of carbon dioxide or inactive gases in a basket made of water molecules are sprayed on the bottom of a cloud, to generate ice crystal groups, which are then charged in an ascending gas stream to absorb vapor in atmosphere under growing to ascend to the upper part of the cloud, where the grown ice crystal groups are fallen in the shape of rain droplets from regions with a weak ascending gas stream to generate artificial rain.

As a method for improving the hydraulic weather phenomenon and an apparatus therefor, for example, those disclosed in JP-A-7-197428 (reference 3) are known. The method for improving the hydraulic weather phenomenon comprises applying a direct current and a high voltage to a Corona discharge wire to generate Corona discharge, applying a direct current and a high voltage in a polarity reverse to or identical to the polarity of the Corona discharge wire to charged particles driven on the basis of the electrical field of the Corona discharge wire to give influences based on the electrical field of the controlled electrical wire, inducing the charged particles to adsorb water in atmosphere onto the charged particles to generate a water condensation reaction to bind atmospheric water molecules together to prepare water droplets to disperse and eliminate fog.

### DISCLOSURE OF INVENTION

### Problem to be Solved by the Invention

By the large-scale vapor mass generation method and the large-scale vapor mass generator as disclosed in the reference 1, a pond shallow and large for drawing seawater therein is formed for a subject dry area such as desert; by covering the upper part of the pond with a dome, a sealed space is formed; and utilizing the elevation of the water temperature in the dome, vapor is generated. Since the dome size or materials for forming the dome are not specifically described therein, the temperature increase in the dome is more gradual inadvertently when the pond is at a state under blocking of direct sunlight in such desert, so that the temperature increase of the seawater is suppressed, leading to the reduction of the vapor generation efficiency and thus never promising of any fog generating vapor mass, disadvantageously.

By the artificial raining method and the apparatus therefor as disclosed in the reference 2, the presence of cloud in the sky is the absolute requirement; toward the cloud, an ice crystal group is charged into an ascending gas stream, while the ice crystal group is absorbing atmospheric vapor under growing until the ice crystal group ascends up to the upper part of the cloud; and then, the grown ice crystal group is fallen in the shape of rain droplets from regions with a weak ascending gas stream. Since the cloud in the sky that exists to block sunlight responsible for global warming is consumed as droplets, disadvantageously, the method and the apparatus therefor work against the prevention of global warming.

By the method for improving the hydraulic weather phenomenon and the apparatus therefor as disclosed in the reference 3, the presence of fog or cloud in the vicinity is the essential requirement; so as to disperse and eliminate the fog or cloud, a direct current and a high voltage are applied to a Corona discharge wire to generate Corona discharge and induce charged particles; atmospheric water is adsorbed onto the charged particles to generate a water condensation reaction to bind atmospheric water molecules together to turn the water molecules into water droplets; as in the reference 2, the fog or cloud existing so as to block sunlight is eliminated, disadvantageously, so that the method and the apparatus work against the prevention of the global warming.

Therefore, the vapor generation method and the vapor generator therefor as described in the reference 1 have a problem to be solved in that the vapor generation efficiency should be improved; and the known techniques described in the references 2 and 3 have problems to be solved in that the methods for inadvertently blocking the prevention of the global warming, which lead to the elimination of cloud or fog existing in atmosphere, should be improved and in that cloud or fog functioning for blocking sunlight should be generated at a large scale.

### Means for Solving the Problem

In a first aspect of the invention for solving the problems, a method for weather modification is provided by using a nuclear fusion reactor or a nuclear fission reactor as a heat source, and a thermal exchanger charged with water to be heated for vapor generation, where the method comprises introducing a circulation pipe for circulating a fluid cooling the nuclear fusion reactor or the nuclear fission reactor or a fluid for thermal exchange in the nuclear fusion reactor or the nuclear fission reactor into the inside of the thermal exchanger to put the fluid in contact with the water to be heated to generate vapor, jetting the vapor at a state of collimation as prepared with a vapor discharge pipe into the sky, and blocking sunlight with the jetted vapor to form a cloud in the sky so as to reduce the temperature on the surface of the earth.

In the first aspect of the invention, preferably, an alkaline vapor heated to a high temperature is jetted in a spray form into the vapor to be jetted into the sky for mixing these vapor types together; additionally, the alkaline vapor is preferably one or two or more of solutions of dissolved burnt lime, milk lime or hydrated lime or alkaline electrolyte water.

In a second aspect of the invention for solving the problems, a vapor generator for weather modification is provided, comprising a nuclear fusion reactor or a nuclear fission reactor as a heat source with a circulation pipe where a fluid for cooling or thermal exchange is circulated, a thermal exchanger capable of withdrawing the water to be heated into vapor from an inlet, and a vapor discharge pipe for discharging vapor as arranged on the upper part of the thermal exchanger, where the circulation pipe extends from the predetermined position into the inside of the thermal exchanger to put the circulation pipe sufficiently in contact with the water to be heated.

In the second aspect of the invention, preferably, a vapor discharge fan for discharging vapor is arranged at a needed position of the vapor discharge pipe; and preferably, a nozzle for jetting the alkaline vapor in a spray form is opened at a needed position of the vapor discharge pipe.

Furthermore, a vapor generator for weather modification is provided, which is produced by mounting the vapor generator for weather modification in the second aspect of the invention on a ship to allow the vapor generator for weather modification transferable on ocean.

The thermal exchanger mounted on a ship is preferably composed of a hole arranged through the ship bottom so as to withdraw seawater and a wall part formed so as to enclose the hole.

### ADVANTAGES OF THE INVENTION

The method for weather modification and the vapor generator for weather modification in accordance with the invention have the following advantages.

(1) Since a nuclear fusion reactor or a nuclear fission reactor is used as a heat source, an enormous volume of vapor can be generated and ascended, absolutely without any discharge of gases with green house effects, such as CO₂, so that clouds blocking sunlight can be generated at a needed position to prevent global warming.
(2) In generating clouds from an enormous volume of vapor, alkaline vapor is generated and mixed into the vapor, for ascending, so that the resulting vapor can neutralize acidic ingredients in the sky or during raining, to neutrality or slight alkalinity, to prevent destructions of nature with acidic rain.
(3) By generating alkaline vapor in aqueous solutions of dissolved lime series such as dissolved burnt lime, the alkaline vapor chemically reacts with atmospheric CO₂ as a gas with a green house effect, to immobilize the gas in the form of a stable substance calcium carbonate for elimination.
(4) By arranging the vapor generator for weather modification on a ship, the vapor generator can be transferred to an appropriate position on ocean to generate necessary clouds.

### BRIEF DESCRIPTION OF DRAWINGS

FIG. 1 is a cross-sectional view schematically showing the vapor generator for weather modification in a first embodiment of the invention;

FIG. 2 is a cross-sectional view schematically showing the vapor generator for weather modification in a second embodiment of the invention;

FIG. 3 is a plane view schematically showing the vapor generator for weather modification in a third embodiment of the invention; and

FIG. 4 is a cross-sectional view schematically showing only the essential part of the vapor generator for weather modification in the third embodiment of the invention.

### BEST MODE FOR CARRYING OUT THE INVENTION

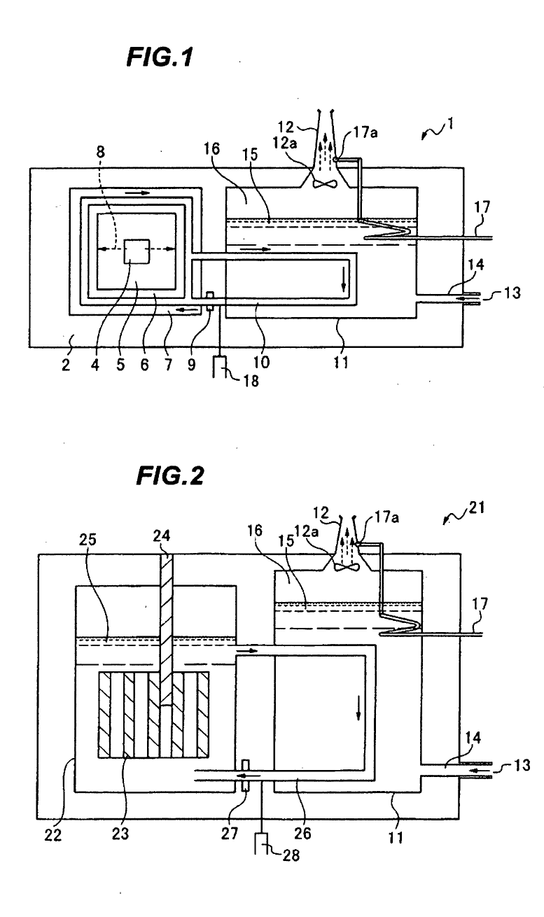

With reference to FIG. 1, first, the vapor generator for weather modification in a first embodiment of the invention is now described.

In the vapor generator 1 for weather modification, a nuclear fusion reactor 2 as an exothermal source for generating an enormous volume of vapor and a thermal exchanger 11 are used. In the center of the nuclear fusion reactor 2, a reactor core 4 sealing high-temperature plasma is arranged, where nuclear fusion reactions frequently occur in the reactor core 4 so that a higher level of energy is generated. The whole circumference of the reactor core 4 is enclosed with a metal wall 5, while on the outer circumference of the metal wall 5, a layer of a substance called a blanket 6 exists. In the substance, lithium 7 is contained and the lithium 7 causes a nuclear reaction with neutron 8 generated via the nuclear fusion reaction in the reactor core 4 to generate thermal energy.

A circulation pipe 10 for circulating a fluid for thermal exchange, for example fresh water or pure water prepared after elimination of any mineral contents, in an enforced manner is arranged throughout the inside of the blanket 6. The circulation pipe 10 extends from the predetermined position into the inside of the thermal exchanger 11. A part of the circulation pipe 10 extending into the inside of the thermal exchanger 11 is preferably formed at a winding state. And the circulation pipe 10 is arranged in such manner that the fluid circulates through an appropriate circulation pump 9 provided outside the thermal exchanger 11 and is again back to the inside of the blanket 6. The thermal exchange principle is substantially the same as the vapor generation principle of nuclear power generation.

The thermal exchanger 11 is in a tank shape as a whole and a water intake pipe 14 connected to a water intake inlet 13 is provided on a side of the thermal exchanger 11, which is closer to the bottom of the vapor generator 1 for weather modification. The upper part (ceiling) of the thermal exchanger 11 is totally sealed, where a vapor discharge pipe 12 is arranged in a part of the center in such manner that the vapor discharge pipe 12 projects upward. The vapor discharge pipe 12 is in a conical shape or an inversed funnel shape with the free end (the upper end) at a smaller diameter, so that generated vapor can be jetted vigorously. Preferably, a fan 12a for vapor discharge is additionally arranged at a needed position of the vapor discharge pipe 12.

Inside the thermal exchanger 11, a given volume of water 15 to be heated such as fresh water or seawater is withdrawn through the water intake inlet 13 and the water intake pipe 14 at a required volume to adjust the water level routinely to such a level that the circulation pipe 10 introduced therein is fallen into a sufficiently water-submerged state and additionally that the space required as the vapor reservoir 16 can be retained in the upper part.

In the thermal exchanger 11, an alkaline water introduction pipe 17 is introduced from the outside, while the alkaline water introduction pipe 17 is drawn out to the upper outside after the alkaline water introduction pipe 17 is put at a state in sufficient contact with the water 15 to be heated; and then, the alkaline water introduction pipe 17 is connected through a spray nozzle 17a to a necessary position of the vapor discharge pipe 12, for example an approximate center thereof, which is then opened. In this case, the alkaline water to be introduced may satisfactorily be for example electrolyzed water at about pH 8 to 12.5, or alkaline water where lime series materials such as burnt lime, milk lime and hydrated lime are dissolved. In any case, one or two or more of these alkaline water types may appropriately be used. Herein, a supply unit 18 for supplying a fluid for thermal exchange at a volume corresponding to a portion of the aforementioned fluid lost spontaneously via circulation, is connected to the circulation pipe 10 in a manner adjacent to the circulation pump 9.

With reference to FIG. 2, the vapor generator 21 for weather modification in a second embodiment of the invention is now described. The vapor generator 21 differs from the vapor generator 1 for weather modification in the first embodiment of the invention in terms of the exothermal source alone, but in terms of other constitutional parts, namely thermal exchanger and the like, the vapor generator 21 is almost the same as the vapor generator 1. Therefore, the other constitutional parts are marked with the same symbols, for skipping the detailed descriptions thereof because of overlapping.

In the vapor generator 21 for weather modification, a nuclear fission reactor 22 is used as an exothermic source, and in the reactor core of the nuclear fission reactor 22, a nuclear fuel 23 is placed and arranged, while a control rod 24 for the nuclear fuel is arranged. Cooling water 25 is circulated in the nuclear fission reactor 22, and for the circulation, a circulation pipe 26 is connected to one of the sides of the nuclear fission reactor 22, and in the circulation pipe 26, a circulation pump 27 and a supply unit 28 of the cooling water 25 are arranged.

A predetermined length of the circulation pipe 26 is introduced into the adjacent thermal exchanger 11 while the circulation pipe 26 is winding, as in the vapor generator 1 for weather modification in the first embodiment of the invention. Since the cooling water 25 exists in the whole circumference of the nuclear fuel 23 in the nuclear fission reactor 22, the cooling water 25 is heated to a high temperature via a nuclear fission reaction.

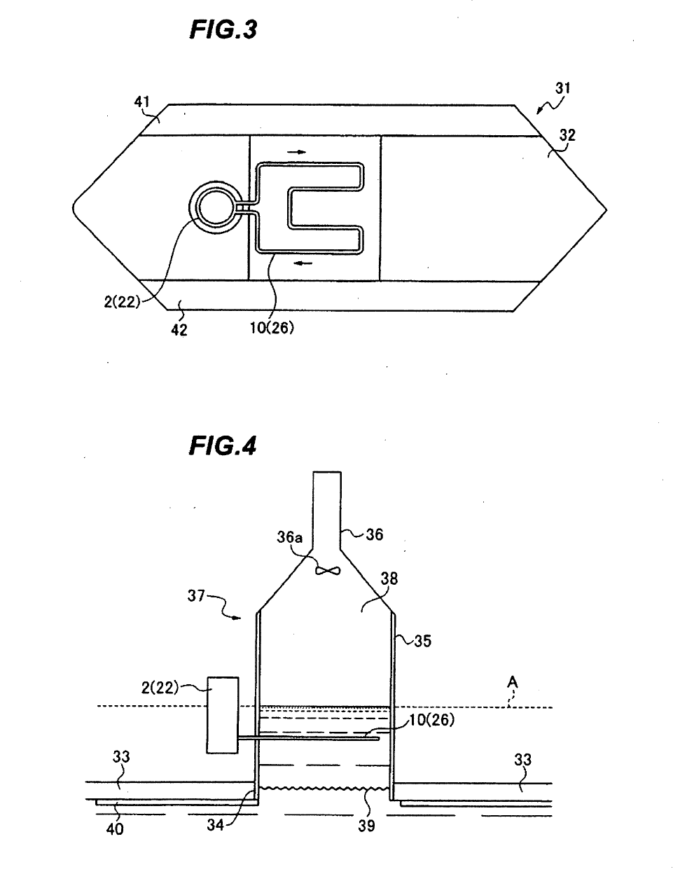

With reference to FIGS. 3 and 4, a vapor generator 31 for weather modification in a third embodiment of the invention is now described.

The vapor generator 31 for weather modification is used on ocean and additionally comprises a ship 32 of a required tonnage, where any of the nuclear fusion reactor 2 or the nuclear fission reactor 22 as a heat source in the first or second embodiment is arranged on the ship 32 for use. As to the thermal exchanger, a thermal exchanger 37 is prepared by opening a hole 34 of a predetermined size through the ship bottom 33 in order that seawater can be used as it is because the vapor generator is used on ocean, arranging a wall part 35 in a standing form from the ship bottom so as to enclose the circumference of the hole 34, arranging a vapor discharge pipe 36 in a conical or inversed funnel shape on the upper part of the wall part 35, and also arranging a fan 36a for vapor discharge at an appropriate position.

In this case, the wall part 35 is extended and formed to a height positioned further upward the waterline A of the ship 32, while the space formed with the wall part 35 and the vapor discharge pipe 36 above the waterline A is a vapor reservoir 38. Structurally, a metal net 39 with a fine mesh for dust removal is arranged in the opening part of the hole 34 through the ship bottom 33, and a shutter plate 40 of a slide type is installed so as to occlude the hole 34. By adjusting the opening level of the shutter plate 40, the fluidity of seawater infiltrated into the hole 34 of the thermal exchanger 37 can be controlled at a certain level.

So as to generate vapor on ocean, in case of the ship 32, the circulation pipes 10, 26 from the nuclear fusion reactor 2 or the nuclear fission reactor 22 should be retained consistently at a state of submersion in water in the thermal exchanger 37. Since the water level as the thermal exchanger 37 should essentially be stabilized to some level, therefore, floats 41, 42 capable of adjusting buoyancy can be arranged on both the sides of the ship so as to adjust the height of the waterline A of the ship 32.

The operations of the vapor generators for weather modification in the individual embodiments of the invention are now described below. Herein, the vapor generation mechanisms thereof are almost the same in the individual embodiments; the vapor generators 1, 21 for weather modification in the first and second embodiments of the invention, respectively are substantially the same except for the single difference in nuclear fusion reactor and nuclear fission reactor. Thus, the operation of the vapor generator 1 for weather modification in the first embodiment of the invention is described but explanation of the operation of the vapor generator in the second embodiment is abbreviated. Additionally, the vapor generator 31 for weather modification in the third embodiment is described in terms of the characteristic different points but explanation of other parts thereof are abbreviated.

First, enormous energy is generated via a nuclear fusion reaction in the reactor core 4 of the nuclear fusion reactor 2 in the vapor generator 1 for weather modification. Since neutron 8 of the energy is emitted in a radiant form, the neutron is subjected to a nuclear reaction with lithium 7 contained in the blanket 6 to generate thermal energy, leading to the temperature elevation of the blanket 6 itself to a high temperature. The fluid for thermal exchange circulates in the circulation pipe 10 extending wholly in the blanket 6 for cooling the blanket 6, while the fluid for thermal exchange is heated to a high temperature inevitably.

In this case, the heated fluid for thermal exchange reaches a temperature close to 200° C. Since the circulation pipe 10 is in a loop shape and the inner pressure therein is retained at an about 200 fold the atmospheric pressure, the fluid can circulate at a state of suppressed boiling. Then, the fluid for thermal exchange as heated to a high temperature is thermally exchanged via the circulation pipe 10 introduced in the thermal exchanger 11, with the water 15 to be heated as placed inside the thermal exchanger 11 for sequential cooling, which is then back to the nuclear fusion reactor 2, where the fluid for thermal exchange as cooled to a low temperature plays a role of cooling the nuclear fusion reactor 2, so that the fluid is heated again to a high temperature; the resulting fluid for thermal exchange as heated to a high temperature is sequentially circulated and transferred back via the circulation pipe 10 to the thermal exchanger 11.

Because the circulation pipe 10 where the fluid for thermal exchange as heated to a high temperature is circulating is in contact with the water 15 to be heated in the thermal exchanger 11, the water 15 to be heated in the contact part and in the vicinity is rapidly heated to the boiling point for vigorous boiling, while the water 15 to be heated on the surface layer turns vapor and evaporates to be filled in the vapor reservoir 16 and be then jetted upward from the vapor discharge pipe 12. By driving the fan 12a for vapor discharge, then, the ascent velocity of the discharged vapor is accelerated, while the vapor reservoir 16 falls to a negative pressure. Hence, vapor evaporation from the water 15 to be heated on the surface layer is enhanced.

Depending on weather conditions (weak or strong winds), the vapor jetted upward from the vapor discharge pipe 12 can be retained at a column shape in more or less accumulation due to the higher temperature of the vapor than the temperature of the outer air therearound and the acceleration of the ascent velocity of the discharge, so that the vapor can continuously ascend. Via the continuous ascend, the vapor can reach the lift condensation level (LCL) of vapor to form cumulonimbus cloud, and additionally, the vapor can further grow together with following vapor, so that a part of the resulting cloud ascends to the level of free convection (LFC), where a stable cloud is formed at a position of a large height.

Herein, the moist adiabatic gradient (° C./100 m) representing that vapor jetted at 100° C. can retain a sufficient buoyancy to retain its ascending gas stream because the vapor is at a temperature higher than the outer atmospheric air temperature even when the vapor ascends to the height of LCL, is calculated and shown below in Table 1. For reference, such calculated values for 90° C. and 80° C. are also shown.

TABLE 1

| Atmospheric pressure (hPa) | 100° C. | 90° C. | 80° C. |
|---|---|---|---|
| 1000 | 0.28 | 0.27 | 0.27 |
| 900 | 0.27 | 0.27 | 0.27 |
| 800 | 0.27 | 0.27 | 0.27 |
| 700 | 0.27 | 0.27 | 0.26 |
| 600 | 0.27 | 0.26 | 0.26 |
| 500 | 0.27 | 0.26 | 0.26 |

As apparently shown above in Table 1, it is understood that because of the small reduction ratio, the jetted vapor can continue to ascend even when the jetted vapor as an ascending gas stream receives a larger atmospheric pressure difference in the sky.

For acid rain elimination and atmospheric CO₂ elimination via chemical reactions, it is needed to generate alkaline vapor to neutralize the acidity or to react with CO₂. Therefore, an alkali electrolyzed water or an aqueous alkaline solution of dissolved lime series at about pH 8 to 12.5 is fed from the alkaline water introduction pipe 17. By jetting and spraying the alkali electrolyzed water or the aqueous alkaline solution as heated together with the water 15 to be heated to a high temperature from the spray nozzle 17a into the inside of the vapor discharge pipe 12, alkaline vapor can be generated and can then be jetted at a state where the alkaline vapor is mixed with the vapor of the water 15 to be heated. The mix ratio of the alkaline vapor in this case is 20% or less of the vapor of the water 15 to be heated.

By preparing a cloud containing the alkaline vapor in such manner, atmospheric components turning acidic rain can be neutralized or can react with CO₂ to immobilize CO₂ as calcium carbonate. Additionally, the cloud can neutralize acidic components even in the course of or after raining on ground when the cloud turns rain and can also react with carbon dioxide existing in the vicinity to immobilize and eliminate CO₂ as calcium carbonate, functionally. Since the cloud can function as described above, the cloud can overcome the problems of acidic rain and the problems of gases with green house effects.

Further, the vapor generation potency of the vapor generator for weather modification in accordance with the invention was examined. The Japan Atomic Energy Agency examined the vapor generation potency thereof, using a nuclear power generator of a nuclear fission reactor type at a thermal output of 3,000,000 Kw (power generation output of 1,000,000 Kw), which was used at a 30-% thermal output. The results are shown below in Table 2.

TABLE 2

| | | |
|---|---|---|
| 1,000,000-Kw class generator | 24-hr operation | 365-day |
| | | operation |
| Vapor generation volume (t) | 400,000 t | 146,000,000 t |

Hence, the vapor generation volume described above can also be obtained from the vapor generator 1 for weather modification with a nuclear fusion reactor in place of a nuclear fission reactor. Provided that 10 nuclear fusion reactors each of a 1,000,000-Kw class are arranged, for example, vapor of a volume 10-fold that of each of the nuclear fusion reactors can be generated, namely 4,000,000 t in 24 hours. Herein, the vapor generation volume is expressed in numerical figure on a water weight basis.

Because the vapor generator 31 for weather modification in the third embodiment is mounted on the ship 32, the vapor generator 31 is transferable anywhere on ocean. So as to block the el Nino phenomenon caused by the elevation of water temperature on ocean, for example, plural such ships equipped with a nuclear fusion reactor 2 of the structure in the first embodiment are placed at anchored states in an equator region on the Atlantic ocean near to Indonesia, as speculated as a source of causing the el Nino phenomenon. By opening the shutter plate 40 on the ship bottom, seawater can be infiltrated inside the hole 34 of the thermal exchanger 37 partitioned with the wall part 35 on the bottom part, to heat the infiltrated seawater to generate vapor.

In this case, the seawater infiltrated into the inside of the hole 34 of the partitioned thermal exchanger 37 is at a state freely movable inwardly or outwardly, but the ship 32 is wholly at a static state because the ship 32 is at the anchored state. The seawater at the static state is heated in the circulation pipe 10 where a fluid for thermal exchange after heating to a high temperature with a nuclear fusion reactor 2 is circulating, so that the surface layer of the seawater reaches a boiling state to generate vapor.

Because a metal net 39 is arranged with a tension on the side of the opening of the hole 34 of the thermal exchanger 37, the metal net 39 can work as a material resistant against fluidity. Since the fluidity of seawater infiltrating into the inside of the hole 34 is under controls, the seawater cannot readily be exchanged with outer seawater. The arranged circulation pipe 10 is preset to a position about 15 to 20 cm above the seawater surface, and the seawater heated with the circulation pipe 10 sequentially ascends, to vigorously generate vapor because the seawater in parts above the circulation pipe 10 becomes boiling, and the generated vapor ascends and is filled in the vapor reservoir 38. Seawater in parts below the circulation pipe 10 is not so much heated, never leading to any temperature elevation of the seawater.

By driving the fan 36a for vapor discharge, the generated vapor is vigorously jetted (discharged) sequentially into atmosphere from the vapor discharge pipe 36. In this case, an enormous volume of vapor is discharged over a long period of time irrespective of day or night, and the discharged vapor in mass is at a temperature higher than the temperature of atmospheric air so that the mass ascends in an ascending gas stream to LCL in the sky, where the mass turns a cloud.

Via cloud formation at LCL in the sky over ocean to block a part of sunlight irradiating the ocean, the elevation of the seawater temperature can be suppressed. Vapor generation throughout years can form an enormous volume of clouds, to enhance sunlight shielding, leading to the suppression of the elevation of seawater temperature.

### INDUSTRIAL APPLICABILITY

The invention is useful as a method for weather modification and an apparatus for weather modification.

1. A method for weather modification by using a nuclear fusion reactor or a nuclear fission reactor as a heat source, and a thermal exchanger charged with water to be heated for vapor generation, the method comprising introducing a circulation pipe for circulating a fluid cooling the nuclear fusion reactor or the nuclear fission reactor or a fluid for thermal exchange in the nuclear fusion reactor or the nuclear fission reactor into the inside of the thermal exchanger to put the fluid in contact with the water to be heated to generate vapor, jetting the vapor at a state of collimation prepared with a vapor discharge pipe into the sky, and forming a cloud in the sky with the jetted vapor for blocking sunlight so as to reduce the temperature on the surface of the earth.

2. A method for weather modification according to claim 1, wherein an alkaline vapor heated to a high temperature is jetted in a spray form into the vapor to be jetted into the sky for mixing these vapor types together.

3. A method for weather modification according to claim 2, wherein the alkaline vapor is preferably one or two or more of solutions of dissolved burnt lime, milk lime or hydrated lime or alkaline electrolyte water.

4. A vapor generator for weather modification, comprising a nuclear fusion reactor or a nuclear fission reactor as a heat source with a circulation pipe where a fluid for cooling or thermal exchange is circulated, a thermal exchanger capable of withdrawing the water to be heated into vapor from an inlet, and a vapor discharge pipe for discharging vapor as arranged on the upper part of the thermal exchanger, where the circulation pipe extends from the predetermined position into the inside of the thermal exchanger to put the circulation pipe sufficiently in contact with the water to be heated.

5. A vapor generator for weather modification according to claim 4, wherein a vapor discharge fan for discharging vapor is arranged at a needed position of the vapor discharge pipe.

6. A vapor generator for weather modification according to claim 4, wherein a nozzle for jetting the alkaline vapor in a spray form is opened at a needed position of the vapor discharge pipe.

7. A vapor generator for weather modification comprising a vapor generator for weather modification according to claim 4 as mounted on a ship, so that the vapor generator may be transferable on ocean.

8. A vapor generator for weather modification according to claim 7, wherein the thermal exchanger mounted on a ship is composed of a hole arranged through the ship bottom so as to withdraw seawater and a wall part formed so as to enclose the hole.
